(19) United States
(12) Patent Application Publication
(10) Pub. No.: US 2013/0054501 A1
(43) Pub. Date: Feb. 28, 2013

(54) Optimizing selection and ordering of items displayed

(71) Applicant: Kenneth Martinus Lassesen, Bellingham, WA (US)

(72) Inventor: Kenneth Martinus Lassesen, Bellingham, WA (US)

(73) Assignee: Kenneth Martin Lassesen, Bellingham, WA (US)

(21) Appl. No.: 13/199,146

(22) Filed: Aug. 22, 2011

(51) Int. Cl. G06N 5/00; G06F 3/048

(52) U.S. Cl. 706/45; 715/810

(57) ABSTRACT

The display of information-items affects user actions on a web site. The ability to objectively and predictively determine the actions of an individual user based on the information-items presented and their display order may result in a significant advantage for the owner of a website, more sales may occur, or a higher user satisfaction may be obtained. This invention describes a method to generate a rich multidimensional collection of user data-vectors, how to use these data-vectors to determine the information-items to display, and their display order; through the application of mathematical methods.

INDEX OF ELEMENTS
101: User Action
102: User Data-store
103: Population Data-store
104: Analysis (Statistical, Data Mining, Artificial Intelligence)
105: Item Data-store (Data Vectors)
106: Display Builder

### TECHNICAL FIELD

The subject matter described herein relates to an apparatus and method for improving the display and effectiveness of customer reviews, user comments and other forms of user contributed information.

### BACKGROUND OF THE INVENTION

Many online businesses provide information through the usage of and/or the sharing of user contributed data or information items. This information may be customer reviews that rate products and vendors, discussion of news items or open discussion on themes. Amazon.com is one well-known example of a company using this business model where product reviews and their ratings are information-items. Amazon.com also uses ratings of third party vendors, which are additional information-items. eBay.com is another well-known example where vendor ratings are information-items. Facebook.com is another well-known example where sharing of links, applications and comments are information-items. Online discussion groups are another well-known example where responses or replies are information-items. Shopping sites display items for sale as information-items (with user purchases being contributed data). News sites are another well-known example where comments and/or polls on stories are information-items. User contributed data will frequently be displayed as an information-item, but this invention does not require this contributed data to be displayed. When the contributed data is not displayed, then the item that is the focus of the contributed data is the information-item. It is desirable to improve the user experience or satisfaction with the information-items presented, as well as to increase the incidence of purchases or production of desired information-items because of this information presentation.

### BRIEF SUMMARY OF THE INVENTION

The invention generally relates to the selection and ordering of information-items presented to the user. Each user of the system can be identified by cookies, internet address, login, browser data (for example browser and operating system language, versions, etc.), as well as past actions they have taken. Past actions include, but are not restricted to, purchases, returns, information-items contributed (which may be prose comments and/or ratings such as “like”, “helpful”, “stars”), pages navigated to, user's behavior on the page or display, and past information-items presented to the user. This data is captured into quantitative and categorical data-vectors persisted in a data-store. This data also may include date-time of actions and the sequence order of actions as well as information-items displayed or seen on pages. The items that are trackable and/or measurable are well known to those practiced in the art of web page construction and user interface construction. An example for illustration would be the capturing, to a data-vector, of the path and timing of mouse movements and clicks across a screen. The path captured in our illustration may provide data-vectors on the hover time over each information-item.

The data-stores are then examined by those practiced in the arts of statistical analysis, data-mining and artificial intelligence to determine relationships between these captured data-vectors and the information-items. Statistical methods may include Logistic Regression, Factor Analysis, Linear Regression, Chi-square and other statistical and mathematical methods not declared. Data mining may include Multifactor Dimensionality Reduction, Association Rule Learning and other techniques not declared. Artificial intelligence may include machine learning, Bayesian network, Kalman filter, hidden Markov models and other techniques not declared, on the data store to create additional or alternative models. The invention is the application of these methods to this business space based on the data-vector types described herein.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An objective is to provide a method that identifies information-items to present to the user that improve the probability of a desired action being undertaken by the user. Some illustrative examples of desired actions include, purchasing a product, placing a product on a wish list, providing a review on a product, providing a rating on a review or a product or a vendor, providing a comment on a prior comment or post, and many other forms not detailed here.

Another objective is to provide a method that identifies the information-items to present to the user that increase user satisfaction on the information-items presented. An illustrative example is presenting comments in a message thread that are likely to solicit a positive comment or reply.

Other objectives and advantages of the present invention will become obvious to the reader and it is intended that these objectives and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

The primary application of this invention is for pages on the internet, but is not restricted to these pages. This invention may also be applied to Kiosk applications and any form of information-item publication that may capture user actions or responses. This invention may be applied to any mechanism for display of information-items. For purposes of illustration, an electronic book reader equipped with biometric scanners is a possible application (in this case, data like heart rate and blood pressure could augment other data-vectors such as the time spent on each page).

### BRIEF DESCRIPTION OF THE DRAWINGS

Various other objects, features and attendant advantages of the present invention will become fully appreciated as the same become better understood when considered in conjunction with the accompanying drawings, in which similar reference characters designate the same or similar parts throughout the several views, and wherein:

FIG. 1: FIG. 1 is a flowchart illustrating the overall operation of the present invention. User Action [101] includes explicit and implicit actions. For example, the explicit action of arriving at a page or display implicitly includes environmental data. This data is recorded into a specific user data-store [102]. [102] may be a multitude of formats, including, but not restricted to, multiple tables in a relational database, computer memory structures, or any other data-storage mechanism such as NoSQL databases.

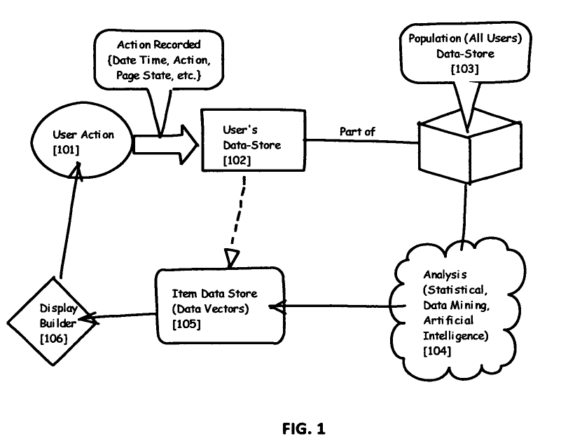

Each user's data-store [102] is part of the population data-store [103] containing all users' data-stores.

The analysis [104] uses methodologies from statistics, data mining and artificial intelligence applied to the population data-stores [103] to produce predictive estimators and/or probability of actions on information-items that could be presented to the user. The methods of obtaining these estimators are varied and well known to those practiced in statistics, data mining and artificial intelligence and are stored as data vectors in the item data store [105].

The estimators on the information-items are used to optimize the building of the page by the display builder [106] for presentation to the user. The optimization may be simple, such as the maximum probability of a specific item or the minimum probability of a different item or the maximum expected financial value resulting from the information-items displayed, or more complex criteria expressed in mathematical formulae.

### DETAILED DESCRIPTION OF THE INVENTION

### A. Overview

Turning now descriptively to the drawings, in which similar reference characters denote similar elements throughout the several views, the figures illustrate the collection of information and its processing to determine optimal presentation items.

### B. User Action

A user action includes actions such as connecting to a site, clicking on a button or link, scrolling the page, entering text, watching an animation or a movie, listening to an audio file, etc. Environmental data includes browser headers (defined by the Internet Engineering Task Force in RFC 2616, RFC 4229, etc., as well as vendor specific additions {Microsoft, Google, FireFox, etc.}), browser data (defined in ECMA-262 and similar documents, as well as vendor specific additions {Microsoft, Google, FireFox, etc.}) and data from sensors and monitors. With current technology, it is possible to determine which information-items on a web page a user sees. In some cases, there may be 30 items on a page, of which only 4 are seen by the user because there are information-items below the viewing area and the user did not scroll down to view these information-items. In other cases, the information-items may be displayed as titles only, which expand to show the information-item when clicked or hovered over.

A users that are known to the system may have all user specific data added to their data-stores as additional data-vectors, for example, age, gender, credit score, address, but not limited to these. Additionally, data-vectors may include references to local and national media (newspapers, radio, television, etc.) data-vectors. For illustration consider this example (which is illustrative, and the invention is not limited to), measures of positive tones in articles dealing with the economy may result in a change of information-items selected for display, for example, more expensive models of a product than usual.

Information-items may be dynamic, static or a combination of the two. The information-items shown and their current state are recorded into the user's data-store. In some cases, this data may be by reference, for example, the ID of a recommendation, or by value, the number of “likes” when it was displayed.

Both the user actions and the displayed information-items are captured. The date-time when each action is taken is also captured.

The user's data-store [102] contains the data-vectors created by the User Action as well as transformations and consequential lookups on the data. An example of a transformation is the looking up of a customers' address against public tax records to determine characteristics of their accommodation, for example, the presence of a yard, and square footage of their accommodation. The data-vectors resulting from the transformation are also stored in the data-store. Another transformation may be the reverse lookup of the browser's Internet Protocol (IP) address to an approximate physical location or IP address owner, for example, the IP address may be owned by a private corporation or an educational institution. Another example of a transformation is the inclusion of events, or weather, occurring in the user's locale. The information-items displayed are also captured in the data-vector; for clarity, the information-items displayed are always deemed a result of a user's action (including the original navigation to the page).

A contributed prose information-item may generate a multitude of dimensions in its data vector beyond the text of the prose information-item. For example, the various readability measures of the prose may be recorded using well-known methods such as Flesch-Kincaid, Gunning-Fog, Coleman-Liau, SMOG and Automated Readability scores. Another collection of measures may be tone (feeling, mood) of the prose. Another collection of measures may be those associated with cadences, rhythmicity, and other literary qualities. Another collection of measures may be the count of items reflecting a class or subset of society, for example, profanity, text-speak, Latin quotations. Each of these measures may be quantified into vectors stored in the user's data-store.

Linkages to other users that are discoverable (for example, Facebook Friends and LinkedIn Contacts) form another collection of data-vectors that may be stored in the user's data-store.

A specific user data-store is part of a collection of all users' data-stores that is referred to as the Population Data-store [103].

The analysis [104] is the application of diverse statistical analysis, data mining and artificial intelligence methods to the data-vectors. This analysis may be executed in a generic way doing a cross product between all vectors or a subset of vectors. The analysis may have been applied in a directed manner. For example, all purchases may be compared against the reported operating system of the browser using Chi-Square methodology to determine any associations; software purchases are often operating system dependent and thus statistical significance is expected.

The analysis may be done from human speculations or by blind testing of the data. The term blind-testing means the systematic testing of one set of data-vectors against another set of data-vectors, which may lack any apparent relevancy. Often this latter process may lead to the application of factor analysis to the most statistically significant factors.

The analysis may result in subsets of users being subject to analysis independent of the entire population data-store. For example, users from a specific location may be used for an analysis.

The results of analysis [104] are data-vectors of values concerning probabilities of the information-item and user actions. The term probability includes all of the dimensions of probability used by those practiced in these arts, for example (but not limited to), probability estimate, confidence interval, type-1 errors, type-2 errors and probability distribution parameters. The data-vector may include correlation to other information-items indicating the relative dependence and/or independence of information-items. For example, an information-item such as a comment like “Excellent Product!” would likely correlate strongly with another information-item such as “Awesome Product.” Correlations may be based on specific information-item identifiers, or patterns of data-vectors, for example, “reviews less than 5 words with a strongly positive tone.”

The process of building a display or page by the display builder [106] is based on optimizing the predictive value of the page built for the specific user that best satisfies the desired objective. This process would use well-known techniques from operations research and mathematical optimization, for example (but not limited to), the methods used in solving the “Knapsack Problem,” adapted for correlations between information-items.

### C. Connections of Main Elements and Sub-Elements of Invention

User Action [101] occurs in the display presenter (for example, a web browser). The data-vector (capturing the action, the information-items and environmental information, etc.) is stored to the user's data-store [102] through diverse means, including but not restricted to, browser code (typically JavaScript), calls and posts to web services or application programming interfaces (API) and subsequently into the data store through the data store language.

The individual user data-store [102] is a part of a data-store containing all users' data-stores; this larger data-store is termed the population data-store [103]. This data-store might not exist in a single place but may be a distributed collection of data servers scattered around the world.

The analysis may be done by commercial packages for statistical, data mining packages and artificial intelligence, such as, Statistical Package for the Social Sciences (SPSS), Statistical Analysis System (SAS), GNU-R, STATISTICA, etc., or by custom written components or a combination of the two. Artificial intelligence and machine learning may be done similarly with commercial packages and custom written components. The data is imported from the population data-store [103] for analysis. The data-vector results are stored in temporary or persistent storage termed item data-store [105].

The item data-store [105] and user data-store [102] are cross-applied to provide predictions for the display builder [106]. The display builder consumes these predictions and optimizes the selection according to a criteria or objective specified by the system owner.

The item data-store [105] allows the display builder [106] to proceed in a prompt manner that does not require analysis each time that a page or display is generated.

### Alternative Embodiments of Invention

There are many variations of the above that do not use the linearity used above for purposes of explanation. As stated above, the number of data-vectors may exceed operational constraints and a reduced set of data-vectors may be used. For example, the use of the browser's declared operating system and time of last post may produce better effects than just the time of last post. The analysis above may be replaced with simple statistics that could be manually computed, such as the number of sales that occur per unit of time with one combination of information-items against an alternative combination of information-items. The intent of this invention is to replace ad-hoc human speculation on how to display information-items with objective statistical measures and models. Contemporary practice is often to display information-items based on the entry-order of a comment, the number of votes (“like”, “useful”) that an information-item has received or some other generic ordering that does not take into account the user's and the population's past actions and behaviors. The speculative ad-hoc approaches of contemporary practice are not evaluated for appropriateness, statistical probability, or goodness-of-fit to actual user behavior. This invention bases the display of information items on quantitative predictive measurements resulting from the application of diverse mathematical and quantitative arts to this business area.

As stated above, user actions such as ordering merchandise, voting for information-items, or replying to information-items are discrete outcome events that are easily measured. A variation is the determination of user satisfaction by surveys, interviews and other subject measures to produce outcome-vectors that may be included in the method described.

One application for this invention is community discussion groups or message boards. This invention would allow the reduction of disruptive communications on the group by displaying to users the information-items that they are likely to comment on in a desired tone (likely a positive tone) and deferring information-items that are likely to produce undesired tone (likely a negative tone).

One application for this invention is a news website that allows comments. This invention would allow the elimination of coarse comments displayed to users that find such language unacceptable.

This invention determines the selection and ordering of information-items for one specific user. An alternative embodiment is determining the selection and ordering of information-items for a group of users that share characteristics.

### D. Operation of Preferred Embodiment

The capture of user actions and derived data-vectors is stored into a data-store. From this data-store, the information-items that best match the current user state for a given objective are determined and presented to the user. As the user changes pages, the user action of ‘going to page XYZ’ is then evaluated against the item data-store and the appropriate information-items are selected.

To illustrate this process, consider the following simple story: Jack, a known customer whose identity is determined by a persistent browser-cookie, arrives at a MyShop.info. MyShop.info's objective criterion is to maximize the probability of purchases. Jack's past data-store identifies that he has purchased soccer shirts for the Cardiff club, and it is determined that Cardiff is currently playing a game (from the date-time of his arrival on the site). The population data-store analysis determines that the most likely purchase for people that have purchased soccer shirts while the club is playing are club beer-can hats and paper club flags. The median number of club beer-can hats purchased is 1, and paper club flags median number is 10. Jack's data-store reports that he has purchased one Cardiff beer-can hat and two Cardiff paper flags. The statistical model assigns a value of 0.8 to the paper club flags and 0.02 to the club beer-can hats. Additional items may be listed with various values less than 0.8, for example, there may be a high correlation of purchases with the purchases done by a subset of friends on Facebook with recent items more probable than older items. The first information-item displayed may be Cardiff paper flags because it has the highest value.

In the above example, the objective criteria was the likelihood of a purchase. Alternative criteria may be the best-expected profit (probability of sale x expected profit). This invention does not make any assumptions as to the nature of the criteria or objective except that it may be transformed or expressed in a quantitative manner that may be evaluated.

What has been described and illustrated herein is a preferred embodiment of the invention along with some of its variations. The terms, descriptions, and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

what is claimed is:

1. A process to determine the selection of information-items to display to a user, and the order of these information-items that would satisfy one or more criteria in an objective way.
a. The process of claim 1 may be applied to web sites showing product reviews.
b. The process of claim 1 may be applied to web sites showing vendor reviews.
c. The process of claim 1 may be applied to web sites offering goods for sale.
d. The process of claim 1 may be applied to web sites hosting discussion groups.
e. The process of claim 1 may be applied to web sites accepting comments.
f. The process of claim 1 may be applied to any display mechanism that can capture user actions.
g. The process of claim 1 may result in an increase of user satisfaction.
h. The process of claim 1 may result in an increase of sales.
i. The process of claim 1 may result in less time being spent on a web site.

2. A process to identify the information-items that are most likely to cause user actions by the application of mathematical methods.
a. The process of claim 2 may be applied to web sites showing product reviews.
b. The process of claim 2 may be applied to web sites showing vendor reviews.
c. The process of claim 2 may be applied to web sites offering goods for sale.
d. The process of claim 2 may be applied to web sites hosting discussion groups.
e. The process of claim 2 may be applied to web sites accepting comments.
f. The process of claim 2 may be applied to any display mechanism that can capture user actions
